(19) United States
(12) Patent Application Publication
(10) Pub. No.: US 2026/0087703 A1
(43) Pub. Date: Mar. 26, 2026

(54) METHOD FOR PROCESSING RECOGNITION RESULTS, RELATED ELECTRONIC DEVICE, NON-TRANSITORY STORAGE MEDIUM, AND COMPUTER PROGRAM PRODUCT

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/315,864

(22) Filed: Sep. 2, 2025

(30) Foreign Application Priority Data
Sep. 26, 2024 (CN) 202411360592.8

(51) Int. Cl. G06T 11/60; G06F 40/166; G06F 40/40; G06V 10/40; G06V 10/77; G06V 10/82; G06V 20/52

(52) U.S. Cl. CPC G06T 11/60; G06F 40/166; G06F 40/40; G06V 10/40; G06V 10/7715; G06V 10/82; G06V 20/52; G06T 2200/24

(57) ABSTRACT

Disclosed are a method for processing recognition results and related devices. A method for processing recognition results includes: obtaining a species image from a user and feature information of the user; recognizing image features of the species image, and extracting content information from a content database based on the recognized image features; inputting the content information and the feature information to a large language model to generate a recognition result page from the content information based on the feature information; displaying the recognition result page provided by the large language model on a user interface.

### CROSS-REFERENCE TO RELATED APPLICATION

This application claims the priority benefit of China application serial no. 202411360592.8, filed on Sep. 26, 2024. The entirety of the above-mentioned patent application is hereby incorporated by reference herein and made a part of this specification.

### BACKGROUND

### Technical Field

The present disclosure relates to information processing technology, and more specifically, relates to a method for processing recognition results, an electronic device, a non-transitory storage medium and a computer program product, and also relates to a maintenance system.

### Description of Related Art

Currently, there are many applications (APP) for recognizing objects, for example applications for recognizing plants, etc. These applications typically receive images from user input, and recognize objects in the images through recognition models based on artificial intelligence technology to obtain recognition results, and present the recognition results to users on user interfaces.

### SUMMARY

A brief overview of the present disclosure is provided below to provide a basic understanding of some aspects of the present disclosure. However, it should be understood that this overview is not an exhaustive overview of the present disclosure. It is not intended to identify key or critical elements of the present disclosure, nor is it intended to limit the scope of the present disclosure. The purpose of the present disclosure is merely to present some concepts of the present disclosure in a simplified form as a prelude to the more detailed description that is presented later.

According to a first aspect of the present disclosure, a method for processing recognition results is provided, including: obtaining a species image from a user and feature information of the user; recognizing an image feature of the species image, and extracting content information from a content database based on the recognized image feature; inputting the content information and the feature information to a large language model (LLM) to generate a recognition result page from the content information based on the feature information; displaying the recognition result page provided by the large language model on a user interface.

In some embodiments, the feature information includes first feature information obtained through historical data of the user.

In some embodiments, the first feature information includes at least one of the following: attribute feature information, the attribute feature information includes maintenance level information; and operation feature information, the operation feature information includes maintenance history information.

In some embodiments, the feature information includes second feature information obtained through interaction data of the user.

In some embodiments, the second feature information includes demand feature information, and the demand feature information includes one or more of focused content information, detail preference information, layout preference information, and reading habit information.

In some embodiments, the method further includes: obtaining one or more information from location information, time information, weather information, and climate information of the user; inputting the species image, the one or more information, and the content information to a multimodal model to adjust the content information based on the species image and the one or more information; and inputting the adjusted content information and the feature information to the large language model to obtain the recognition result page.

In some embodiments, the method further includes: displaying an interactive question about recognizing the species image on the user interface; receiving a user input including a reply to the interactive question, where the user input includes at least one of image, text, audio, or video; inputting the species image, the user input, and the content information to the multimodal model to adjust the content information based on the species image and the user input; and inputting the adjusted content information and the feature information to the large language model to obtain the recognition result page.

In some embodiments, the method further includes: inputting the species image, the content information and a preset content framework to an artificial intelligence generated content (AIGC) model to supplement the content information, where the supplemented content information includes content that is missing from the content information compared to the preset content framework; and inputting the supplemented content information and the feature information to the large language model to obtain the recognition result page.

In some embodiments, the feature information includes the focused content information, and the method includes: inputting the focused content information, the species image, and the content information to the AIGC model to supplement the content information, where the supplemented content information includes content that is missing from the content information compared to the focused content information; and inputting the supplemented content information and the feature information to the large language model to obtain the recognition result page.

In some embodiments, the feature information includes detail preference information, and the method includes: inputting the detail preference information, the species image and the content information to the AIGC model to regenerate the content information, the regenerated content information has a detail level that conforms to the detail preference information; and inputting the regenerated content information and the feature information to the large language model to obtain the recognition result page.

In some embodiments, the recognition result page includes one or more content modules.

In some embodiments, the one or more content modules are divided according to topics. The recognition result page further includes a first-level dividing line located between each of two adjacent content modules in the one or more content modules.

In some embodiments, the recognition result page further includes a first-level title located before each of the content modules in the one or more content modules.

In some embodiments, the first-level title is determined based on a summary of the content module, or determined based on a key point of the content module.

In some embodiments, each of the content modules of the one or more content modules includes one or more paragraphs divided according to a contextual relationship, and the recognition result page further includes a second-level dividing line located between each of the two adjacent paragraphs in the one or more paragraphs.

In some embodiments, the recognition result page further includes a second-level title located before each paragraph in the one or more paragraphs.

In some embodiments, the second-level title is determined based on a summary of the paragraph, or determined based on a key point of the paragraph.

In some embodiments, a keyword and/or a key sentence in the one or more paragraphs are highlighted.

In some embodiments, the one or more paragraphs are arranged according to an ordered list or an unordered list.

In some embodiments, the recognition result page does not include the first-level title before the content module located at the front of the recognition result page in the one or more content modules.

In some embodiments, the large language model is trained with first training data. The first training data includes a combination of first text indicating content information and second text indicating feature information as samples. The first training data further includes a recognition result page as a label of the samples.

In some embodiments, the multimodal model is trained with second training data. The second training data includes a combination of the species image serving as the sample, first text indicating content information serving as an object to be processed, and data of any one or more modalities indicating reference information serving as a processing reference. The second training data further includes second text indicating content information serving as a processing result of a label serving as the sample.

In some embodiments, the AIGC model is trained with third training data. The third training data includes a combination of the species image serving as the sample, the first text indicating the content information serving as the object to be processed, and the second text indicating the reference information serving as the processing reference. The third training data further includes third text indicating the content information serving as the processing result as the label of the sample.

In some embodiments, the method includes: generating a maintenance plan based on the recognition result page, the maintenance plan includes one or more pairs, each pair of the one or more pairs includes one or more maintenance tasks and an identifier of a maintenance device for executing the one or more maintenance tasks; displaying the maintenance plan on the user interface.

In some embodiments, the method includes: controlling a corresponding maintenance device based on the identifier of the maintenance device in each pair of the one or more pairs in the maintenance plan to complete the one or more maintenance tasks in the pair.

According to a second aspect of the present disclosure, an electronic device is provided, including: one or more processors; and a memory storing computer-executable instructions. The computer-executable instructions, when executed by the one or more processors, enable the one or more processors to execute the method for processing recognition results according to any embodiment in the first aspect of the present disclosure.

According to a third aspect of the present disclosure, a non-transitory storage medium having computer-executable instructions stored therein is provided. The computer-executable instructions, when executed by a computer, enable the computer to execute the method for processing recognition results according to any embodiment in the first aspect of the present disclosure.

According to a fourth aspect of the present disclosure, a computer program product is provided. The computer program product includes instructions. The instructions, when executed by a processor, implement the method for processing recognition results according to any embodiment in the first aspect of the present disclosure.

According to a fifth aspect of the present disclosure, a maintenance system is provided, including: an electronic device. The electronic device includes a processor and a memory coupled to the processor and storing instructions. The instructions, when executed by the processor, enable the processor to: obtain a species image from a user and feature information of the user; recognize an image feature of the species image, and extract content information from a content database based on the recognized image feature; input the content information and the feature information to a large language model to generate a recognition result page from the content information based on the feature information; generate a maintenance plan based on the recognition result page, where the maintenance plan includes one or more pairs, each pair of the one or more pairs includes one or more maintenance tasks and an identifier of a maintenance device for executing the one or more maintenance tasks; and transmit a command to the corresponding maintenance device based on the identifier of the maintenance device in each pair of the one or more pairs in the maintenance plan to control the corresponding maintenance device to complete the one or more maintenance tasks in the pair. The maintenance system further includes a maintenance device communicatively coupled with the electronic device, wherein the maintenance device is configured to execute the maintenance task in response to receiving the command from the electronic device.

In some embodiments, the maintenance device is configured to transmit execution data to the electronic device in response to execution of the maintenance task, wherein the instructions include an instruction that, when executed by the processor, enable the processor to execute the following operations: updating the feature information of the user based on the execution data received from the maintenance device.

In some embodiments, the maintenance system includes: a camera communicatively coupled to the electronic device. The camera is configured to capture the species image and transmit the captured species image to the electronic device. The instructions include an instruction that, when executed by the processor, enable the processor to perform the following operations: generating the recognition result page based on the species image received from the camera.

### BRIEF DESCRIPTION OF THE DRAWINGS

From the following description of embodiments of the present disclosure shown in conjunction with the accompanying drawings, the foregoing and other features and advantages of the present disclosure will become apparent. The drawings are incorporated herein and form a part of the specification, and are further used to explain the principles of the present disclosure and enable those skilled in the art to make and use the present disclosure.

FIG. 1 shows a flowchart of a method for processing recognition results according to some embodiments of the present disclosure;

FIG. 2 shows a schematic view of an exemplary user interface in which a method for processing recognition results according to some embodiments of the present disclosure is applied;

FIG. 3 exemplarily shows a schematic view of a recognition result page obtained through applying a method for processing recognition results according to some embodiments of the present disclosure;

FIG. 4 exemplarily shows training data for training a large language model according to some embodiments of the present disclosure;

FIG. 5 exemplarily shows training data for training a multimodal model according to some embodiments of the present disclosure;

FIG. 6 exemplarily shows training data for training an AIGC model according to some embodiments of the present disclosure;

FIG. 7 shows a schematic block diagram of an electronic device according to some embodiments of the present disclosure;

FIG. 8 shows a schematic block diagram of a computer system on which some embodiments of the present disclosure may be implemented;

FIG. 9 shows a schematic block diagram of a maintenance system according to some embodiments of the present disclosure.

Note that in the implementation methods described below, the same reference numerals may sometimes be used in common between different drawings to represent the same parts or parts having the same function, and repeated description thereof may be omitted. In some cases, similar numerals and letters are used to represent similar elements, so once an element is defined in one drawing, it does not need to be further discussed in subsequent drawings.

For ease of understanding, the positions, dimensions, and ranges of various structures shown in the drawings and the like may sometimes not represent actual positions, dimensions, and ranges. Therefore, the present disclosure is not limited to the positions, dimensions, and ranges disclosed in the drawings and the like.

### DESCRIPTION OF THE EMBODIMENTS

Various exemplary embodiments of the present disclosure will be described in detail below with reference to the accompanying drawings. It should be noted that: unless otherwise specifically stated, the relative arrangement of components and steps, numerical expressions and numerical values set forth in these embodiments do not limit the scope of the present disclosure.

The following description of at least one exemplary embodiment is actually merely illustrative and in no way serves as any limitation on the present disclosure and its application or use. That is, the structures and methods herein are shown in an exemplary manner to illustrate different embodiments of the structures and methods in the present disclosure. However, those skilled in the art will understand that they merely illustrate exemplary methods that may be used to implement the present disclosure, rather than exhaustive methods. Furthermore, the drawings are not necessarily drawn to scale, and some features may be enlarged to show details of specific components.

Additionally, techniques, methods, and equipment known to those of ordinary skill in the relevant field may not be discussed in detail, but where appropriate, the techniques, methods, and equipment should be considered as part of the specification.

In all examples shown and discussed herein, any specific values should be interpreted as merely exemplary, and not as limitations. Therefore, other examples of the exemplary embodiments may have different values.

A page (hereinafter referred to as “recognition result page”) presenting recognition results in a user interface typically contains a large amount of text information and image information. For users, it often takes a considerable amount of time to completely read the large amount of information in the recognition result page to obtain the information they focus on (for example, the species of organisms (such as plants), recognition results of symptoms), and they cannot quickly grasp the key points. In addition, some applications may highlight some information presented on the recognition result page to remind users. However, the types of key information that are highlighted are often fixed settings, and the key content that different users focus on often varies, so prompting the same key information cannot satisfy personalized requirements of the user.

For this purpose, the present disclosure provides a method for processing recognition results, which performs personalized adjustment on a display method of content information of a recognition result through a large language model based on feature information of the user, thereby being able to customize the displayed recognition result page for the user according to personal characteristics of the user, filter content that the user should focus on and content that the user is interested in from a large amount of information, help the user quickly grasp key points, improve information transmission efficiency and enhance user experience.

The following will describe in detail methods for processing recognition results according to various embodiments of the present disclosure in combination with the accompanying drawings. It may be understood that actual methods for processing recognition results may also include other steps, but in order to avoid obscuring the main points of the present disclosure, these other steps are not discussed herein and are not shown in the accompanying drawings.

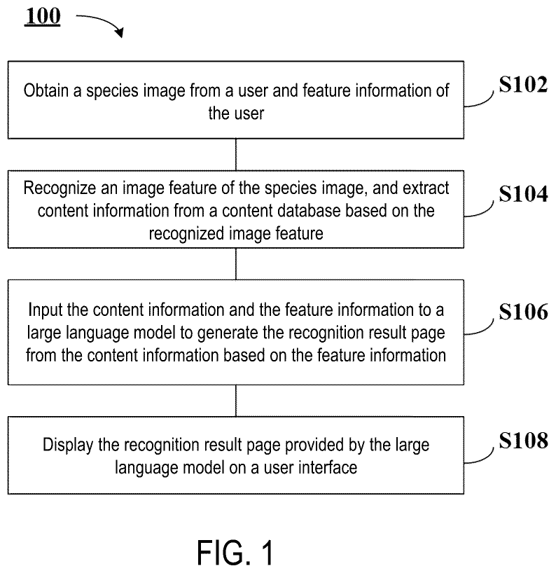

FIG. 1 shows a flowchart of a method 100 for processing a recognition result according to some embodiments of the present disclosure. As shown in FIG. 1, the method 100 includes:

At step S102, obtaining a species image from a user and feature information of the user;

At step S104, recognizing an image feature of the species image, and extract content information from a content database based on the recognized image feature;

At step S106, inputting the content information and the feature information to a large language model to generate the recognition result page from the content information based on the feature information;

At step S108, displaying the recognition result page provided by the large language model on a user interface.

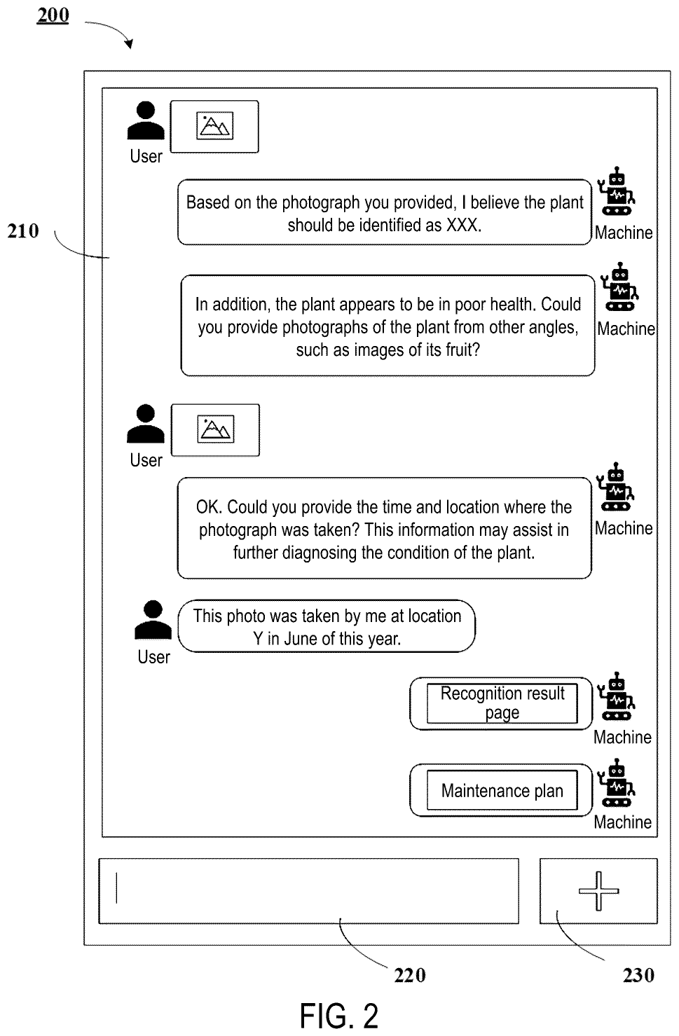

Specifically, recognizing the species in the species image may include, for example, recognizing the type and/or symptom of the species in the species image. Correspondingly, the content information extracted from the content database based on the recognized image feature may include content about recognizing the type and/or symptom of the species in the species image. In addition, before recognizing the image feature of the species image, the species image may also be preprocessed. The preprocessing may include normalization, brightness adjustment, or noise reduction. As a non-limiting example, a user interface 200 as shown in FIG. 2 may be provided. The user interface 200 includes a dialog box 210, an input box 220, and an input button 230, where the input box 220 is configured to receive text input by the user, and the input button 230 is configured to receive images, audio, video, etc. input by the user.

For example, the content information may be pre-stored in the content database, such that in response to the species image uploaded by the user, corresponding content information may be extracted from the content database. For example, the content database may store species names, species maintenance information, species symptoms and corresponding treatment and prevention methods, etc. The content information about the species may be stored in the content database in association with image features of the species. The content information may be extracted based on a matching degree between the image feature of the recognized species image and the image features of the species stored in the content database, for example, when the matching degree falls within a preset range. As a non-limiting example, a cosine similarity between a first vector representing the image feature of the recognized species image and a second vector representing the image features of the species stored in the content database may be calculated. When the calculated cosine similarity exceeds a preset threshold, the image feature of the recognized species image is considered to match the image feature of the species stored in the content database, and content information stored in the content database in association with the matched image feature is extracted.

Additionally, for example, a recognition model may be established based on neural networks (such as deep convolutional neural networks) or deep residual networks, and the species image may be recognized through a pre-trained (or referred to as “trained”) recognition model to obtain image features. After the recognition model recognizes the image feature of the species image, the content information related to the species image may be extracted from the content database based on the image feature.

In some embodiments, the feature information of the user includes first feature information obtained through historical data of the user. As a non-limiting implementation, the historical data of the user may be stored in a user database. For example, when the user uploads the species image to an application, the user is normally in a logged-in state, so the user's account information is known, and therefore the historical data of the user may be retrieved from the user database based on the user's account information to obtain the user's first feature information. Exemplarily, the first feature information may include attribute feature information and/or operation feature information. The attribute feature information may include maintenance level information and the like. For example, if the user has previously maintained multiple plants and the growth states of the plants are all good, it indicates that the user's maintenance level is high. Conversely, if the user has never maintained plants or the growth states of the maintained plants are all poor, it indicates that the user's maintenance level is low. The operation feature information may include maintenance history information and the like. For instance, there was an occasion when the user, while tending to a particular plant, merely watered the plant after the plant became diseased, resulting in the plant's withering. This indicates that the user's actions were incorrect and untimely. Conversely, there was another instance where the user, while caring for a specific plant, proactively implemented preventive measures before the plant entered a susceptible period, thereby ensuring the plant's healthy growth. This demonstrates that the user's actions were both correct and timely.

In some embodiments, the user's feature information includes second feature information obtained through the user's interaction data. In some examples, the interaction data may be historical interaction data representing the user's historical interaction operations, or may be current interaction data representing the user's current interaction operations. Exemplarily, the second feature information may include requirement feature information. The requirement feature information may include one or more of focused content information, detail preference information, layout preference information, reading habit information, etc. With reference to the user interface 200 shown in FIG. 2, for example, for the current interaction data, the user may input the user's own feature information through the input box 220. For example, the user may input in text or voice form “please provide care precautions for this species”, “please omit species detail information for this species”, “please bold the symptom diagnosis results and treatment measure key points for this species” and other instructions to enable the large language model to adjust the presented recognition result page based on the user's feature information. In another example, for historical interaction data, the user has previously deleted some content modules that they were not interested in from historically presented recognition result pages, therefore, when currently presenting the recognition result page, those content modules are automatically hidden to avoid the user having to manually delete them again, improving user experience. Of course, the user's interaction operations may also include various interaction operations such as clicking, doodling, annotation, etc.

After obtaining the content information about the species image input by the user and the feature information about the user, the content information and the feature information may be input to the large language model to generate a personalized recognition result page for the user. In some cases, the content information extracted from the content database may be input to the large language model as is. In other cases, the content information extracted from the content database may be preprocessed before being input to the large language model, so that the content information is able to better meet user requirements.

In some aspects, more user-related information may be introduced through multimodal models to obtain more accurate and highly relevant content information, thereby improving the effective information density and information transmission efficiency of the recognition result pages generated based on the adjusted content information.

A multimodal model refers to a machine learning model that can process and understand information from multiple modalities (such as text, images, audio, video, etc.). The multimodal model improves understanding and generation capabilities by integrating different types of data, and are capable of capturing correlations between different modalities, thereby providing richer context and more accurate output. Non-limiting examples of multimodal models include such as CLIP, DALL-E, GPT-4, etc.

For example, taking the processing of two modality data, including image and text, as an example. In some embodiments, the multimodal model may only include a multimodal large language model for processing image features and text features. In other embodiments, the multimodal model may include one or multiple vision models in series or parallel for extracting image features and a multimodal large language model coupled to the downstream of the vision model for processing image features and text features. Through specific vision models, the expressive capability of image features may be enhanced, thereby optimizing the performance of multimodal models on visual tasks. Vision models may be established based on various suitable neural network architectures, such as ResNet, DenseNet, etc. Exemplarily, the vision model may be a convolutional neural network (CNN) Transformer model, include but not limited to ConvNext model. To improve the expressive capability of such vision models in specific application domains (for example, plant recognition domain), the vision models may be trained with image-text pairs (for example, plant image-text pairs) through contrastive learning, which will be described in more detail later. For example, the CNN Transformer model may first be separately pre-trained with image-text pairs through contrastive learning, then jointly trained with the downstream multimodal large language model by using multimodal data. This way, it is beneficial to enhance the overall performance of the multimodal model. Of course, the CNN Transformer model may also be pre-trained separately first, then when training the multimodal model with the multimodal data, the parameters of the CNN Transformer model are fixed while only the parameters of the multimodal large language model are updated, which may accelerate training speed and reduce computational and storage resources consumed by training.

It can be understood that the same applies to other multimodal data. For instance, if audio data also needs to be processed, the multimodal model may be provided by employing a large multimodal language model that processes audio features, image features, and text features. This can be achieved either independently or in conjunction with one or both of the following: a visual model for extracting image features and an auditory model for extracting audio features.

For instance, consider a scenario where the multimodal model receives both image data (I) and text data (T), while in other circumstances, additional modalities of data may also be present. The image data may include, but is not limited to, user-inputted images (such as images of species), images similar to the user-inputted ones sourced from a content database, and template images corresponding to recognition results (for example, recognized species or symptoms). The text data may encompass, but is not limited to, various types of data inputted by the user, such as location data, time data, weather data, and climate data. It is understood that the aforementioned historical data and interaction data, among others, can also be received by the multimodal model in various modalities.

Upon receiving the aforementioned multimodal data, the multimodal model must first convert these diverse types of data into feature representations compatible within the model to facilitate the integrated processing of these varied data types. This is typically achieved through the use of individual encoders specific to each modality.

Specifically, the multimodal model may convert the image data and the text data into corresponding feature representations through an image encoder fI (for example, Convolutional Neural Network (CNN), Recurrent Neural Network (RNN), etc.) and a text encoder fT (for example, Word2Vecmodel, Bag of Words (BoW) model, etc.), respectively, that is,

$$VI = fI ( I ) , \\ VT = fT ( T ) ,$$

Wherein, VI represents image feature representation, VT represents text feature representation, I represents image data, and T represents text data.

After converting different types of data into corresponding feature representations, feature integration may be performed to integrate feature representations of different modalities into a unified feature representation for inputting into the model for further processing or prediction. Integration may be achieved using simple concatenation, weighted average, and/or more complex integration mechanisms (such as attention-based integration mechanisms, etc.). Specifically, for example, Vfused=βVI+(1−β)VT, where Vfused represents the unified feature representation, and B represents a parameter that adjusts the importance of VI and VT in the integration process. It should be understood that the specific integration method may be selected based on actual circumstances to achieve optimal performance.

In some embodiments, the method 100 includes: obtaining one or more information from location information, time information, weather information, and climate information of the user; inputting the species image, the one or more information, and the content information to the multimodal model to adjust the content information based on the species image and the one or more information; and inputting the adjusted content information and the feature information to the large language model to obtain the recognition result page.

As a non-restrictive embodiment, assume that after recognition by the recognition model, it is determined that the species in the user's input species image is a tomato plant, and that the tomato plant has flowers. It is understood that the maturation period of tomatoes varies depending on different times (such as seasons, months, etc.) and different climates. For example, from March to April, when the temperature is relatively low, it takes 50 to 60 days for tomatoes to mature from flowering to fruiting. From May to June, when the temperature is suitable, it takes 45 to 50 days for tomatoes to mature from flowering to fruiting, and from July to August, when the temperature is higher, it takes approximately 40 days for tomatoes to mature from flowering to fruiting. When the user uploads an image of the tomato in March, the content information extracted from the content database may include the maturation period information for tomatoes to mature from flowering to fruiting in all three scenarios. This means that if all the content information extracted from the content database is presented verbatim on the recognition result page, the user would need to read through a substantial amount of “noise” information, leading to low efficiency in acquiring the target information. In this embodiment, the multimodal model can further adjust the content information based on the user's time information (e.g., March) so that the adjusted content information only includes the maturation period information for tomatoes to mature from flowering to fruiting in March. Consequently, the recognition result page provided by the large language model can simply display “Tomatoes take 50 to 60 days to mature from flowering to fruiting.” Therefore, the content displayed on the recognition result page is clear and straightforward for the user. It is understood that although this disclosure uses plant images as species images to describe embodiments, this is merely exemplary and not restrictive; the species images may also be images of any other species, such as animal images.

In some embodiments, the method 100 includes: displaying an interactive question about recognizing the species image on the user interface; receiving an user input including a reply to the interactive question, where the user input includes at least one of image, text, audio, or video; inputting the species image, the user input, and the content information to the multimodal model to adjust the content information based on the species image and the user input; and inputting the adjusted content information and the feature information to the large language model to obtain the recognition result page.

For example, when the recognition model experiences situations such as inability to converge, insufficient confidence in output results, or insufficient precision in output results, it may be considered that the recognition model cannot provide image features sufficient to accurately extract the content information from the content database. This may be caused by various reasons such as the presence of many species in the species image without knowing which species is the target species, the species image being too blurry, etc. Additionally, the content information may be extracted from the content database based on the matching degree with the image feature. When there are multiple content information that match the image feature, they may all be extracted, but possibly only a portion of them is what the user truly needs. In these situations, more information (especially highly discriminative information) may be obtained by proposing interactive questions to generate accurate and reliable content information. For example, the interactive questions may include requests for voice/text descriptions about the target species, close-up images or videos of one or more characteristic parts of the target species, etc. Assuming the species in the species image input by the user has a symptom, the interactive questions may include requests for one or more of close-up images of one or more affected parts of the species, capturing time of the species image, capturing location of the species image, and maintenance details of the species.

Furthermore, an interactive question chain may be designed, and then the interactive questions may be output sequentially along the interactive question chain until the obtained information is sufficient to provide the content information for recognizing the species in the species image. For example, for recognizing symptoms of the species in the species image, a close-up image of the affected part of the species may be first requested. If the accuracy of the content information still does not meet expectations, the capturing time and capturing location of the species image may be further requested.

For the purpose of non-restrictive illustration, for example, please refer to FIG. 2. The user provides a plant image. Based on the plant image provided by the user, while the species of the plant in the image is determined, since it is also recognized that the plant appears to have symptoms, the user is requested to provide photos of this plant from other angles, such as close-up photos of the fruit. In addition, since the diagnosis of plant symptoms requires consideration of multiple factors to accurately diagnose whether the plant is diseased and what the symptoms are, the user is requested to provide the time and location when the photos were taken. After the user responds that the photo was taken in June of this year at location Y, the content information extracted from the content database is adjusted through the multimodal model using the collected user input, and then a recognition result page generated by the large language model based on the adjusted content information is displayed to the user.

It may be understood that, except for replying to the interactive questions, the user may also proactively provide user input, and these user inputs may also be used by the multimodal model for adjusting the content information.

In some aspects, the content information may be enhanced/optimized through an AIGC model. The AIGC model is capable of automatically generating various types of content using artificial intelligence technology, including text, images, audio, video, etc. These models are established typically based on complex algorithms and deep learning architectures, capable of completing creative generation, content creation and other tasks in various applications. The main types of the AIGC model include text generation models, image generation models, audio generation models, video generation models, etc., or any combination thereof. The AIGC model may adopt general models, for example GPT, Llama, Gemini, ERNIE Bot, etc., or may adopt self-developed models.

In some embodiments, the method 100 includes: inputting the species image, the content information and a preset content frame work to the AIGC model to supplement the content information, where the supplemented content information includes the content missing from the content information compared with the preset content framework; and inputting the supplemented content information and the feature information to the large language model to obtain the recognition result page.

As a non-restrictive embodiment, for example, the species in the species image uploaded by the user is a diseased plant, and the preset content framework for the recognition result page for the diseased plant is assumed to include three parts: plant species, symptom type, and treatment measures. However, the content information extracted from the content database only includes plant species and symptom type, but does not include treatment measures. Therefore, after inputting the species image, the content information, and the preset content framework to the AIGC model, the AIGC model supplements the content information to enable the supplemented content information to further include treatment measures.

Since the information stored in the content database is relatively fixed and limited, the content information extracted from the content database may be deficient in some cases. Therefore, introducing the AIGC model may improve the completeness of the content information configured to generating the recognition result page.

In some embodiments, in the case where the feature information includes focused content information, the method 100 includes: inputting the focused content information, the species image and the content information to the AIGC model to supplement the content information, where the supplemented content information includes content missing from the content information compared to the focused content information; and inputting the supplemented content information and the feature information to the large language model to obtain the recognition result page.

As a non-limiting embodiment, the species in the species image uploaded by the user is a diseased plant, and the content information extracted from the content database includes plant species, symptom type, and treatment measures, but the user also focuses on preventive measures. Therefore, after inputting the species image, the content information, and the focused content information indicating “focus on preventive measures” to the AIGC model, the AIGC model supplements the content information to enable the supplemented content information to further include preventive measures, thereby enabling the recognition result page generated by the large language model to display information that conforms to the user's focus preferences, thus further optimizing the user experience.

In some embodiments, in the case where the feature information includes detail preference information, the method 100 includes: inputting the detail preference information, the species image and the content information to the AIGC model to regenerate the content information, where the regenerated content information has a level of detail that conforms to the detail preference information; and inputting the regenerated content information and the feature information to the large language model to obtain the recognition result page.

As a non-restrictive embodiment, the species in the species image uploaded by the user is a diseased plant, and the content information extracted from the content database includes plant species, symptom types, treatment measures, and prevention measures. For plants that the user maintains personally, the user usually knows the species of the plant and therefore does not need to understand the species information of the plant. In contrast, the user is very concerned about the symptom types and treatment measures of the plant, and expects to learn about the prevention measures for the symptom incidentally. Therefore, after inputting the species image, the content information, and the detail preference information indicating “do not mention plant species, elaborate on symptom types, elaborate on treatment measures, and briefly describe prevention measures” to the AIGC model, the AIGC model may regenerate the content information to enable the content information to include detailed content about the symptom types and treatment measures of the plant and summarized content about the prevention measures for the symptom of the plant, thereby enabling the recognition result page generated by the large language model to display information that conforms to the user's detail preferences, thus further optimizing the user experience.

It may be understood that content information extracted from the content database may be input to the large language model as is, or may be processed by one or both of the multimodal model and the AIGC model in any desired order according to specific requirements, and input to the large language model after processing for use in generating the recognition result page.

Compared to directly displaying the content information in the recognition result page, the recognition result page generated by the large language model based on the user's feature information from the content information may have a specific format and content, thereby significantly improving user experience.

In some embodiments, the recognition result page includes one or more content modules. For example, one or more content modules may be divided according to topics. The recognition result page may also include a first-level dividing line located between each of two adjacent content modules in the one or more content modules, so as to help the user visually distinguish the content modules of different topics easily.

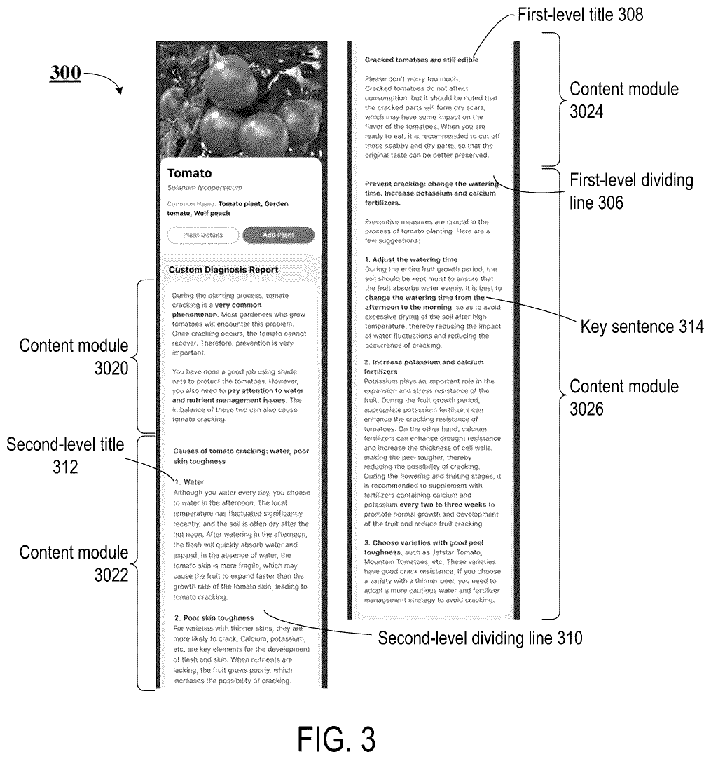

Referring to FIG. 3, FIG. 3 shows a schematic view of a recognition result page 300 in which recognition results obtained according to some embodiments of the present disclosure are applied. As shown in FIG. 3, the recognition result page 300 includes four content modules, namely a content module 3020 for introducing a diagnostic report as an opening, a content module 3022 for illustrating the causes of tomato cracking, a content module 3024 for illustrating the edibility of cracked tomatoes, and a content module 3026 for illustrating preventive measures for tomato cracking. In FIG. 3, there are first-level dividing lines depicted as dashed lines between the content module 3020 and the content module 3022, between the content module 3022 and the content module 3024, and between the content module 3024 and the content module 3026. To simplify the drawing, only the first-level dividing line between the content module 3024 and the content module 3026 is denoted with a reference numeral 306. It may be understood that the first-level dividing line and the second-level dividing line to be mentioned later may adopt any suitable style, including but not limited to the illustrated dashed lines, blank lines, etc.

In some embodiments, the recognition result page further includes a first-level title located before each content module in the one or more content modules. For example, the first-level title maybe determined based on a summary of the content module, or determined based on a key point of the content module.

As a non-limiting embodiment, continuing to refer to FIG. 3, the recognition result page 300 includes a first-level title “Causes of tomato cracking: water, poor skin toughness” located before the content module 3022, a first-level title “Cracked tomatoes are still edible” located before the content module 3024, and a first-level title “Prevent cracking: change the watering time. Increase potassium and calcium fertilizers” located before the content module 3026. For simplifying the drawings, only a reference numeral 308 is used to denote the first-level title before the content module 3024.

It is not imperative for the large language model to distill the first-level title into more concise conventional titles (such as “Causes,” “Edibility,” “Precautions”). Instead, while ensuring the accuracy of the first-level title for each of the content modules, the flexibility of these first-level titles should be maintained. This allows the first-level title itself to convey the core idea of the respective content module, enabling the user to immediately discern the main focus of the content module from the first-level title. For instance, a succinct expression like “Cracked tomatoes are still edible” inherently communicates the main idea of the content, thereby transmitting more information to the user more swiftly and accurately compared to conventional titles like “Edibility.”

Of course, it may be understood that if the content of the content module is extensive and cannot express the focus of the content module through the first-level title, the first-level title may also be refined into a conventional title.

Additionally, the recognition result page may not include the first-level title before the content module located at its front. For example, as shown in FIG. 3, there is no first-level title before the content module 3020. The introductory title for introductory-type content as the opening is not necessary, and in some cases, omitting the title may render the reading experience more natural for the user.

In some embodiments, each content module within the one or more content modules of the recognition result page includes one or more paragraphs divided according to a contextual relationship. For instance, the recognition result page may further include a secondary-level dividing line located between each of two adjacent paragraphs within the one or more paragraphs, in order to prevent the occurrence of large continuous blocks of text, thereby facilitating the reduction of the user's reading burden.

As a non-limiting embodiment, continuing to refer to FIG. 3, taking the content module 3022 as an example, the content module 3022 includes a first paragraph and a second paragraph, wherein the first paragraph is used to describe one cause of tomato cracking—water, and the second paragraph is used to describe another cause of tomato cracking—poor skin toughness. In addition, the recognition result page 300 includes a second-level dividing line 310 located between the first paragraph and the second paragraph of the content module 3022 and depicted as a blank line.

In some embodiments, the recognition result page further includes a second-level title located before each paragraph in one or more paragraphs, for example, the second-level title may be determined based on a summary of the paragraph, or determined based on a key point of the paragraph.

As a non-limiting embodiment, continuing to refer to FIG. 3, the recognition result page 300 further includes a second-level title “1. Water” located before the first paragraph of the content module 3022 and a second-level title “2. Poor skin toughness” located before the second paragraph of the content module 3022. To simplify the drawing, only a reference numeral 312 is used to denote the second-level title before the first paragraph of the content module 3022. Through the second-level title, the user may quickly learn the main content of each paragraph, thus improving information transmission efficiency.

In the example of FIG. 3, the first-level title 308 of the content module 3022 includes the second-level titles of two paragraphs of the content module. Therefore, the large language model may refer to the second-level titles of paragraphs included in the content module when determining the first-level title of the content module. Conversely, the large language model may also refer to the first-level title of the content module when determining the second-level titles of paragraphs included in the content module.

Through setting the first-level titles and the second-level titles, the key information in the recognition result page may be expressed concisely, so that the user does not have to spend effort summarizing what content the recognition result page actually expresses, thereby improving user experience. In some situations, especially when the first-level titles and the second-level titles are determined based on key points of related content, the user may even grasp the main theme of the entire text solely by reading the titles, without the necessity of reviewing the specific content of each paragraph. Alternatively, the user can directly locate the content of interest through the titles for further detailed reading.

In some embodiments, the one or more paragraphs are arranged in an ordered list. As a non-limiting embodiment, continuing to refer to FIG. 3, the content module 3022 is adopted as an example, it can be observed that the first paragraph and the second paragraph each contain ordinal numbers “1” and “2” in their respective second-level titles. Since the first paragraph and the second paragraph represent two parallel arguments concerning the “causes of tomato cracking,” the first paragraph and the second paragraph may be arranged in an ordered list. Certainly, in situations where the one or more paragraphs have progressive relationships, general-particular relationships, particular-general relationships, or other textual relationships, the ordered list may also be used to arrange the one or more paragraphs. In other embodiments, the one or more paragraphs are arranged in an unordered list. Since paragraphs using an ordered list may also contain one or more paragraphs intended for further elaboration, an unordered list may also be used to arrange the paragraphs.

In some embodiments, keywords and/or key sentences in the one or more paragraphs are highlighted. For example, the keywords/key sentences may be words or phrases that directly affect and/or guide the user's judgment and/or operations, words or phrases that answer questions the user cares about, words or phrases that need to draw the user's attention, and so on. Continuing to refer to FIG. 3, for example, a key sentence 314 “change the watering time from the afternoon to the morning” in a paragraph in a content module 3026 is bolded for highlighting, and the key sentence 314 directly affects and guides the user's watering operations. Additionally, as shown in FIG. 3, since the first-level title 308 and the second-level title 312 are determined based on key points, they may also be considered as keywords/key sentences, and are therefore also bolded for highlighting. Highlighting keywords and/or key sentences helps users quickly locate key information from numerous pieces of information, thereby improving information transmission efficiency and enhancing user experience.

For illustrative purposes, a non-limiting exemplary application of the method 100 may include symptom diagnosis of plants. In this example, the species image input by the user is an image including a diseased plant. The image feature is recognized by inputting the image to a segmentation attention model. Since the segmentation attention model is specifically optimized for image segmentation, the segmentation attention model is able to recognize and accurately segment key structures and symptom regions in the image. Through efficient segmentation techniques, the segmentation attention model is able to generate a precise image mask containing pathological information to serve as the recognized image feature, which may provide a good basis for subsequent diagnostic analysis. The content information may be extracted from the content database (specifically, disease database) based on the image feature recognized by the segmentation attention model.

After image segmentation is completed, the image and the content information are correctly understood and processed through the multimodal model, for example including a description of a segmentation result, an indication of a symptom feature, and a possible diagnostic issue. In addition, the multimodal model may also focus on key information in the image through prompt information input by the user, and combine the information with the content information extracted from the content database (specifically, disease database). The multimodal model may recognize a specific pathological feature in the image, combine the features with text descriptions, and classify symptoms or provide diagnostic recommendations individually or in combination with the large language model and/or the AIGC model. The processing capability of the multimodal model for different types of data and the capability to integrate the information to make accurate diagnoses are utilized to adjust and/or supplement the content information. In addition, the adjusted and/or supplemented content information is also integrated into a detailed diagnostic report through the large language model and displayed to the user. The diagnostic report not only includes possible diagnostic results, but also describes in detail the diagnostic basis, the recognized pathological feature, and a recommended follow-up treatment plan. The report shows a key image region and a segmentation result through a visualization method, enabling the user to quickly understand the analysis process and conclusions of the model, thus providing support for the user's treatment decisions.

Specific training datasets may be set for each model of the present disclosure, so that the models are trained to have different processing capabilities.

In some embodiments, the large language model is trained with first training data. The first training data includes a combination of first text indicating content information and second text indicating feature information as samples. The first training data further includes a recognition result page as a label of the samples.

In some examples, the recognition result page serving as the label of the sample may be an expert perfect answer created by experts based on the corresponding first text and second text. The first training data may be used to train the large language model until the output of the large language model meets the requirements. For example, an error between the recognition result page generated by the large language model and the recognition result page serving as the label may be determined; in response to the error being not less than a predetermined error threshold range, parameters of the large language model are updated based on the error; and in response to the error being less than the predetermined error threshold range or in response to the number of updates exceeding a predetermined number threshold, the training of the large language model is ended and a trained large language model is obtained. The trained large language model is able to understand the user's feature information and the content information so as to process the content information based on the user's feature information to obtain the recognition result page that conforms to the user's characteristics. The style of the recognition result page output by the large language model may be adjusted by adjusting the first training data.

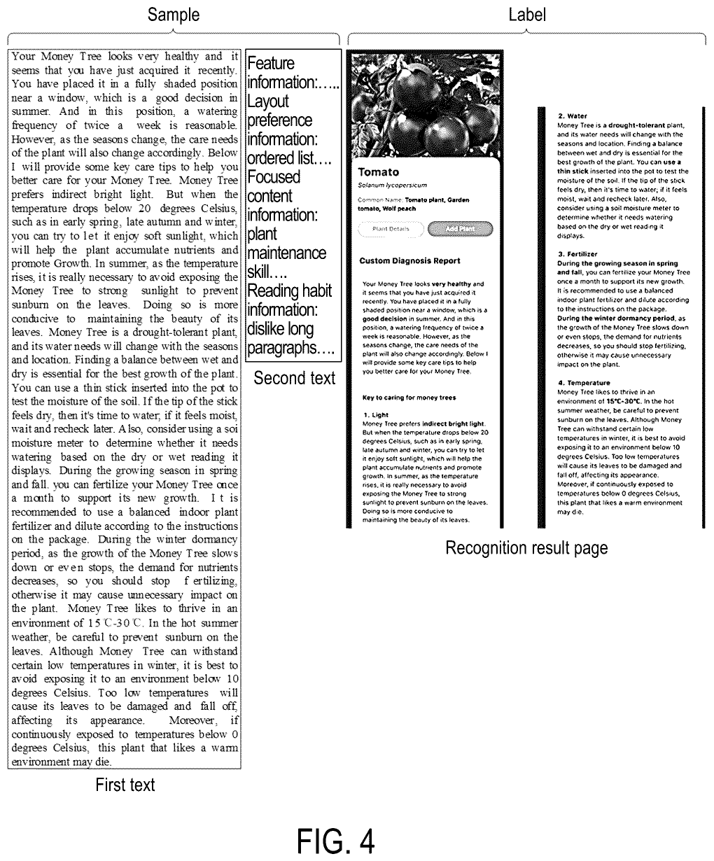

Referring to FIG. 4, the first training data for the large language model is exemplarily shown. It may be seen that the first text in the sample is the content information serving as an object to be processed, which is represented as a long string of continuous text, which will cause a huge reading burden for the user. The second text in the sample indicates the user's feature information, which tells the large language model that the user focuses on plant maintenance techniques, likes ordered lists, and dislikes long paragraphs. The recognition result page serving as the label of the sample may divide the long paragraph into two content modules—an opening introduction module and a maintenance technique introduction module, and divide the maintenance technique introduction module into multiple paragraphs arranged in an ordered list. In addition, each paragraph of the recognition result page serving as the label of the sample also has highlighted words and sentences to indicate the key information of the corresponding paragraph.

In some embodiments, the multimodal model is trained with second training data. The second training data includes a combination of species images serving as samples, first text indicating content information serving as an object to be processed, and data of any one or more modalities indicating reference information serving as a processing reference. The second training data further includes second text indicating content information serving as a processing result of the label serving as the sample.

In some examples, the second text serving as the label of the sample may be an expert perfect answer created by experts based on the corresponding species image, the first text, and the modal data. The second training data may be used to train the multimodal model until the output of the multimodal model meets the requirements. For example, an error between the second text generated by the multimodal model and the second text serving as the label may be determined; in response to the error being not less than a predetermined error threshold range, parameters of the multimodal model may be updated based on the error; and in response to the error being less than the predetermined error threshold range or in response to the number of updates exceeding a predetermined number threshold, the training of the multimodal model may be ended and a trained multimodal model may be obtained. The trained multimodal model may understand the user's requirements and thus process the content information according to the user's requirements to obtain the content information that meets the user's requirements. The content information output by the multimodal model may be adjusted by adjusting the second training data.

Exemplarily, the training process of the multimodal model may include a pre-training stage and a fine-tuning training stage. Correspondingly, the second training data may include a pre-training dataset and an instruction fine-tuning dataset.

For example, in the context of processing both image and text modalities using the multimodal model, the pre-training dataset may include a substantial number of image-text pair data from the relevant application domain. In the domain of plant species identification and/or symptom diagnosis, the dataset may include pairs of species images and text describing the plant varieties depicted in the images, and/or pairs of species images and text describing the diagnostic results of diseases affecting the plants in the images. These image-text pairs may undergo manual annotation or similar processing.

For example, the aforementioned CNN Transformer model may adopt contrastive learning based on plant image-text pairs in the pre-training stage, and the specific training process may be as follows. For plant image-text pairs input to the CNN Transformer model, an image feature is extracted by an image encoder thereof, and a text feature is extracted by a text encoder thereof. Assuming that a training batch includes N plant image-text pairs, the image encoder will extract N image features, and the text encoder will also extract N text features. The N image features and the N text features are combined pairwise, thereby obtaining N² samples. For each of the image features, there are 1 positive sample and (N−1) negative samples. For each of the text features, there are 1 positive sample and (N−1) negative samples. In total, there are N positive samples and (N²-N) negative samples. The training objective may be to maximize the similarity of the N positive samples (for example, the cosine similarity between the text features and the image features may be directly calculated). The training process is equivalent to a multi-classification task, and cross-entropy loss may be calculated. Through contrastive learning, the expressive capability of visual features of the CNN Transformer model may be enhanced, thereby improving the performance of the multimodal large language model on visual tasks, and ultimately enhancing the plant recognition capability of the entire multimodal model.

Through pre-training, the tokenization encoded by the visual model in the multimodal model and the tokenization encoded by the multimodal large language model in the multimodal model may be aligned in semantic space, enabling the multimodal large language model to also obtain the ability to view images (i.e., visual capability).

The instruction fine-tuning dataset may be set according to specific tasks. Specifically, multiple basic tasks within the domain may first be defined. For example, for the plant domain, basic tasks may include symptom diagnosis of plants. Then, the user inputs his/her focus points/requirements/problems and basic information about plant images, and through constructing instructions, a set of multi-turn dialogue data is obtained. By analogy, all related problems within the plant domain are constructed into multi-turn dialogues, thereby forming the instruction fine-tuning dataset for fine-tuning training of the multimodal model, enabling the multimodal model to have the capability of completing question-and-answer for various problems within the plant domain, thereby being able to integrate the input information feedback by the user into the content information. Through the above interaction method, the multimodal model may achieve improved recognition accuracy and reliability based on the original recognition capability by using prior knowledge, additional information and reasoning capability.

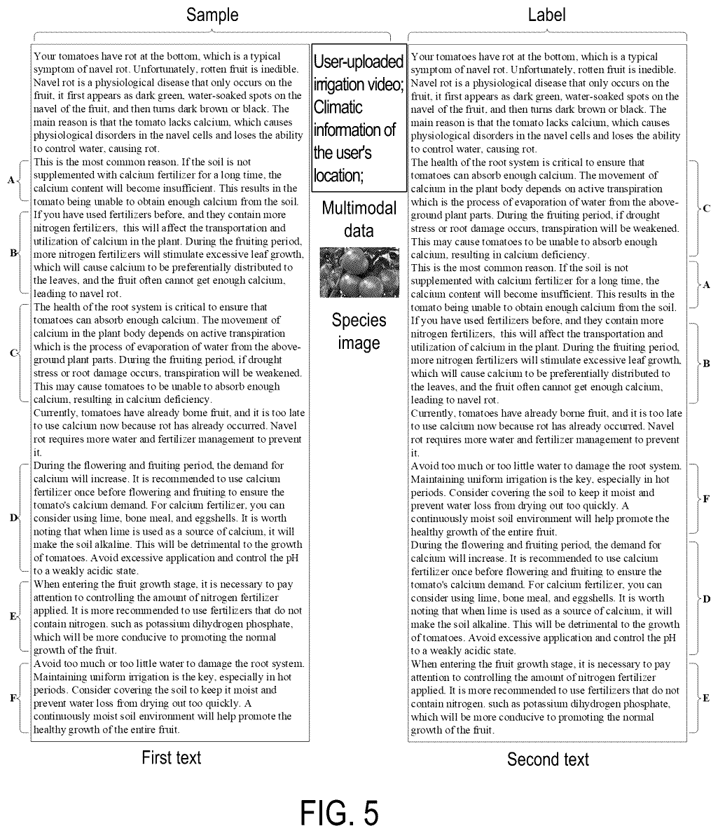

Referring to FIG. 5, FIG. 5 exemplarily shows the second training data for the multimodal model. It may be seen that the first text in the sample serves as the content information of the object to be processed, which describes three common causes leading to calcium deficiency in tomato fruits in A-B-C order. Part A is used to describe soil calcium deficiency, part B is used to describe tomato fruits' inability to utilize calcium, and part C is used to describe insufficient watering. In the meantime, preventive measures are described in D-E-F order. Part D is used to describe calcium supplementation during critical periods, part E is used to describe reasonable control of fertilization, and part F is used to describe control of watering. The modal data serving as the processing reference in the sample includes watering videos uploaded by the user and text indicating climate information of the user's location, which reflect that the climate at the user's location is dry and the user's watering amount is very little. The sample also includes species images. The second text serving as the label of the sample may adjust the writing order relative to the first text by moving the part C to the first common cause (i.e., describing three common causes leading to calcium deficiency in tomato fruits in C-A-B order), and moving the part F to the first preventive measure (i.e., describing preventive measures in F-D-E order).

In some embodiments, the AIGC model is trained with third training data. The third training data includes a combination of the species image serving as the sample, the first text indicating the content information serving as the object to be processed, and the second text indicating the reference information serving as the processing reference. The third training data further includes third text indicating the content information serving as the processing result as the labels of the sample.

In some examples, the third text serving as the label of the sample may be an expert perfect answer created by experts based on the corresponding species image, the first text, and the second text. The third training data may be used to train the AIGC model until the output of the AIGC model meets the requirements. For example, an error between the third text generated by the AIGC model and the third text serving as the label may be determined; in response to the error being not less than a predetermined error threshold range, parameters of the AIGC model may be updated based on the error; and in response to the error being less than the predetermined error threshold range or in response to the number of updates exceeding a predetermined number threshold, the training of the AIGC model may be ended and a trained AIGC model may be obtained. The trained AIGC model may understand the user's needs and thus process the content information according to the user's needs to obtain the content information that meets the user's needs. The content information output by the AIGC model may be adjusted by adjusting the third training data.

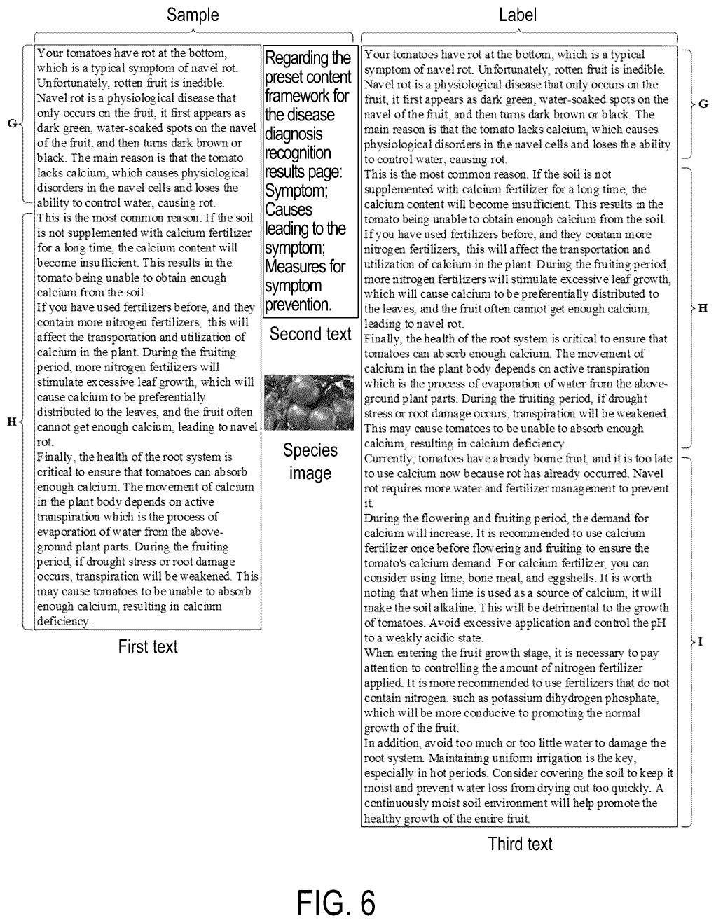

Referring to FIG. 6, FIG. 6 exemplarily shows the third training data for the AIGC model. It can be seen that the first text in the sample is the content information serving as the object to be processed, which includes a part G for describing symptoms and a part H for describing causes leading to the symptoms. The second text serving as the processing reference in the sample includes a preset content framework for symptom diagnosis recognition result pages, which includes symptoms, causes leading to symptoms, and measures for preventing symptoms. The sample also includes the species image. The third text serving as the label of the sample may supplement a part I for describing measures for preventing symptoms relative to the first text.

For example, the training method of autoregressive language models may be used to train the multimodal model, the large language model, and the AIGC model. The training process of autoregressive language models is based on large amounts of text data to calculate a probability distribution of each word appearing given the preceding word sequence. Specifically, the model treats each word in the training data as a discrete random variable, and then uses the maximum likelihood estimation method to calculate the conditional probability distribution of each word given the preceding word sequence, which may be utilized to generating and predicting text sequences. Specifically, the model treats the text sequence as a random variable sequence X1, X2, . . . , XT, where each random variable represents a word. The model assumes that the word at the current time is only related to a finite number of preceding words, that is, the word Xt at the current time is only related to the preceding word sequence X1, X2, . . . , Xt−1 (t=1, 2, . . . , T), which is the Markov assumption. According to Bayes' theorem, the probability P(xt+1|X) of the word xt+1 appearing at the next time may be represented as: P(xt+1|X)=P (xt+1|X1, X2, . . . , Xt). Since the appearance probability of each word in the text sequence is affected by the preceding words, the above formula may be further expanded: P(xt+1|X)=P (xt+1|xt, xt−1, . . . , x1). This formula means that the appearance probability of the next word depends on the appearance of the preceding words, that is, if the preceding word sequence is known, the appearance probability of the next word may be predicted based on conditional probability.

For example, for the multimodal model, as described above, after receiving multiple types of the modal data, the multimodal model first needs to convert these different types of data into compatible feature representations for integration of these different types of data. For the second training data used for the multimodal model, in addition to the first text therein, the species images therein and the data of any one or more modalities indicating the reference information may also be respectively converted into text-like inputs, and then integrated with the first text to obtain an integrated text sequence. Next, the multimodal model may encode words in the integrated text sequence to map each word to a vector representation with a fixed length, and model the encoded words to obtain an output (for example, when the multimodal model is constructed based on RNN, the encoded word sequence may be input to the RNN for modeling to obtain the output of the RNN; when the multimodal model is constructed based on the Transformer model, a multi-head self-attention mechanism may be used to model the encoded word sequence to capture dependency relationships between different positions, thereby obtaining the output of the Transformer), and convert the output into a probability distribution of the next word through a related function (for example, softmax function). During training, the multimodal model may use a cross-entropy loss function to enable the prediction result of the multimodal model to be as close as possible to the text sequence of the second text serving as the label.

It is understandable that the large language model and the AIGC model may adopt a training process similar to that of the aforementioned multimodal models, which is derived from the autoregressive language model concept. Therefore, further elaboration on this matter is unnecessary.

After obtaining the recognition result page, related tasks may be generated and displayed to the user based on the content in the recognition result page, particularly the key information therein (for example, highlighted keywords or key sentences, etc.). In the case where a device with executable tasks is connected, the corresponding device may also be automatically controlled to execute the task.

Specifically, in some embodiments, the method 100 may include: generating a maintenance plan based on the recognition result page, the maintenance plan including one or more pairs, each pair of the one or more pairs including one or more maintenance tasks and an identifier of a maintenance device for executing the one or more maintenance tasks; displaying the maintenance plan on the user interface.

In some examples, the maintenance plan may be generated based on key information in the recognition result page. For example, the maintenance plan may be generated based on one or more of the title, keywords, and/or key sentences in the recognition result page.

The maintenance plan may include daily maintenance plans, treatment maintenance plans, etc., or combinations thereof. For example, when the recognition result page does not involve symptoms of the species, the daily maintenance plan for the species may be output. When the recognition result page involves symptoms of the species, the treatment maintenance plan for the species may be output, and optionally, a matching daily maintenance plan may also be output.

For illustrative purposes, a non-limiting exemplary application of the method 100 may include symptom diagnosis of tomato plants maintained by the user. In this example, the leaves and fruits of the tomato plant in the species image input by the user begin to rot, so the recognition result page finally generated based on the species image may include a symptom module, a pathogen module, a treatment measure module and a prevention measure module for tomatoes with fruit rot. To further help the user maintain the tomato, the maintenance task may be generated based on the content in the recognition result page, particularly the content highlighted in the treatment measure module (for example, specific treatment timing, treatment drugs, treatment frequency, etc.). After generating the maintenance task based on the recognition result page, since the content database also stores the identifier of the maintenance device communicatively coupled with a user terminal, the identifier of the maintenance device associated with the maintenance task may also be determined from the content database based on the maintenance task, thereby generating the maintenance plan. After obtaining the maintenance plan, as shown in FIG. 2, the maintenance plan may be displayed on the user interface. In this way, the user is able to know what kind of maintenance devices should be used (for example, irrigation devices, fertilization devices, pruning devices, medication devices, lighting control devices, temperature control devices, humidity control devices, etc., or combinations thereof) and what kind of maintenance tasks should be implemented to maintain the tomatoes. The maintenance task may include, for example, watering, spraying, fertilizing, pruning, weeding, pot rotation, sunlight exposure, shading, temperature adjustment, humidity adjustment, application of insecticides, and application of fungicides, etc. Specifically, the maintenance task may also include various parameters of the tasks, for example, watering time, intervals, water amount, fertilization dosage, time, intervals, pruning locations, pesticide spraying dosage and locations, etc.

In some embodiments, the method 100 may include: controlling the corresponding maintenance device based on the identifier of the maintenance device in each pair of the one or more pairs in the maintenance plan to complete the one or more maintenance tasks in the pair.

Since the maintenance device typically have communication functions, commands may be transmitted to the maintenance devices (for example, via Bluetooth protocol, Zigbee protocol, etc.). For example, in the example, the maintenance plan may include two pairs: {fruit pruning task and leaf pruning task, identifier of pruning device} and {pesticide spraying task, identifier of dosing device}. Based on the identifiers, commands indicating execution of the pruning task and spraying task are respectively sent to the corresponding pruning device and the spraying device, thereby controlling the pruning device and the spraying device to automatically complete the pruning task and the spraying task, and further reducing the user's maintenance burden and improving maintenance efficiency.

Besides automatically executing the maintenance plan, in some embodiments, after displaying the maintenance plan, further inquiry may be made to ascertain whether the user confirms the execution of the maintenance plan. After the user confirms execution of the maintenance plan, the corresponding maintenance device is controlled according to the maintenance plan to complete the corresponding maintenance task. For example, after the user confirms execution of the maintenance plan, the user's feature information may be updated based on the maintenance plan, such as maintenance level information, maintenance history information, etc. After the maintenance plan is executed, the user's feature information may also be updated based on execution data returned by the maintenance device, such as the maintenance level information, the maintenance history information, etc. In this way, when the user's species image is obtained again, the recognition result page and the corresponding maintenance plan may be generated in combination with the updated user's feature information.

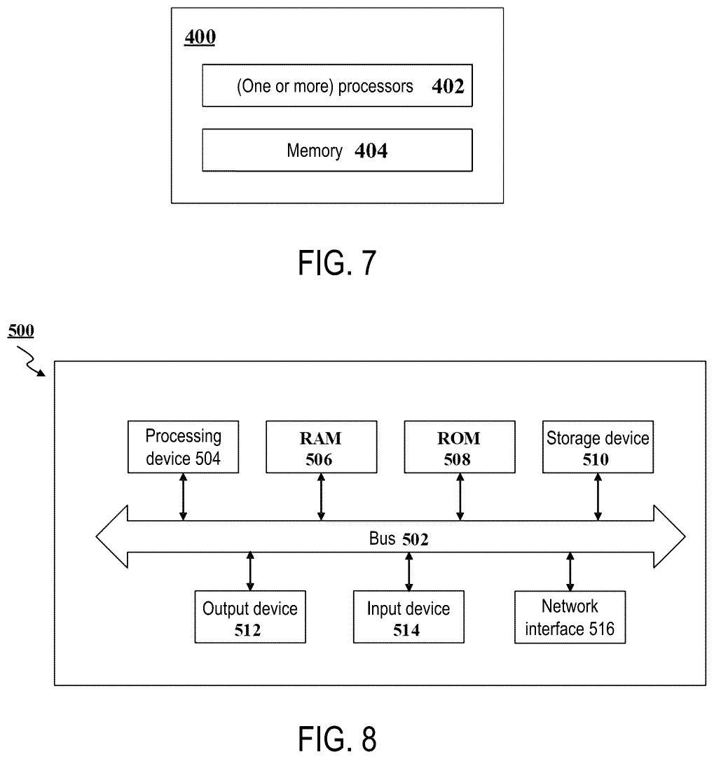

Another aspect of the present disclosure also provides an electronic device. Referring to FIG. 7, FIG. 7 shows a schematic block diagram of an electronic device 400 according to some embodiments of the present disclosure. As shown in FIG. 7, the electronic device 400 includes (one or more) processors 402 and a memory 404 storing computer-executable instructions. The computer-executable instructions, when executed by the (one or more) processors 402, enable the (one or more) processors 402 to execute the method for processing the recognition result described in any of the aforementioned embodiments of the present disclosure. The (one or more) processors 402 may be, for example, a central processing unit (CPU) of the electronic device 400. The (one or more) processors 402 may be any type of general-purpose processor, or may be a processor specifically designed for processing the recognition result, such as an application-specific integrated circuit (“ASIC”). The memory 404 may include various computer-readable media accessible by the (one or more) processors 402. In various embodiments, the memory 404 described herein may include volatile and non-volatile media, removable and non-removable media. For example, the memory 404 may include any combination of the following: random access memory (“RAM”), dynamic RAM (“DRAM”), static RAM (“SRAM”), read-only memory (“ROM”), flash memory, cache memory, and/or any other type of non-transitory computer-readable media. The memory 404 may store instruction that, when executed by the processor 402, enable the processor 402 to execute the method for processing the recognition result described in any of the aforementioned embodiments of the present disclosure. In some embodiments, the electronic device 400 may be implemented as a smartphone, a smart camera, a computer, etc.

The present disclosure also provides a non-transitory storage medium having computer-executable instructions stored therein. The computer-executable instructions, when executed by a computer, enable the computer to execute the method for processing the recognition result described in any of the foregoing embodiments of the present disclosure.

The present disclosure also provides a computer program product. The computer program product may include instructions. When the instructions are executed by a processor, the method for processing the recognition result described in any of the foregoing embodiments of the present disclosure may be implemented. The instructions may be any instruction set that is executed directly by one or more processors, such as machine codes, or any instruction set that is executed indirectly, such as scripts. The instructions may be stored in object code format for direct processing by one or more processors, or stored in any other computer language, including scripts or collections of independent source code modules that are interpreted on demand or compiled in advance.

FIG. 8 shows a schematic block diagram of a computer system 500 on which embodiments of the present disclosure may be implemented. The computer system 500 includes a bus 502 or other communication mechanism for transmitting information, and a processing device 504 coupled with bus 502 for processing information. The computer system 500 also includes a memory 506 coupled with the bus 502 for storing instructions to be executed by the processing device 504, where the memory 506 may be a random access memory (RAM) or other dynamic storage devices. The memory 506 may also be configured to storing temporary variables or other intermediate information during execution of instructions to be executed by the processing device 504. The computer system 500 also includes a read-only memory (ROM) 508 or other static storage devices coupled to the bus 502 for storing static information and instructions for the processing device 504. A storage device 510, such as a magnetic disk or an optical disk, is provided and coupled to the bus 502 for storing information and instructions. The computer system 500 may be coupled via the bus 502 to an output device 512 for providing an output to the user, including but not limited to a display (such as a cathode ray tube (CRT) or liquid crystal display (LCD)), speakers, etc. The input device 514, such as keyboards, mice, microphones, etc., are coupled to the bus 502 for transmitting information and command selections to the processing device 504. The computer system 500 may execute the embodiments of the present disclosure. Consistent with some embodiments of the present disclosure, results are provided by the computer system 500 in response to the processing device 504 executing one or more sequences of one or more instructions contained in the memory 506. Such instructions may be read into the memory 506 from another computer-readable medium, such as the storage device 510. Execution of the instruction sequences contained in the memory 506 causes the processing device 504 to execute the methods described herein. Alternatively, hard-wired circuitry may be used in place of or in combination with software instructions to implement the present teachings. Thus, implementations of the present disclosure are not limited to any specific combination of hardware circuitry and software. In various embodiments, the computer system 500 may be connected across a network via a network interface 516 to one or more other computer systems like the computer system 500 to form a networked system. The network may include a private network or a public network such as the Internet. In a networked system, the one or more computer systems may store data and supply the data to other computer systems. As used herein, the term “computer-readable medium” refers to any medium that participates in providing instructions to the processing device 504 for execution. Such medium may take many forms, including but not limited to non-volatile media, volatile media, and transmission media. The non-volatile media include, for example, optical or magnetic disks such as the storage device 510. The volatile media include a dynamic memory such as the memory 506. The transmission media include coaxial cables, copper wires, and optical fibers, including the wiring that includes the bus 502. Common forms of the computer-readable media or the computer program products include, for example, floppy disks, flexible disks, hard disks, magnetic tape, or any other magnetic medium, CD-ROM, digital video disk (DVD), Blu-ray disk, any other optical medium, thumb drives, memory cards, RAM, PROM and EPROM, flash EPROM, any other memory chip or cartridge, or any other tangible medium from which a computer can read. Various forms of the computer-readable media may be involved in carrying the one or more sequences of the one or more instructions to the processing device 504 for execution. For example, the instructions may initially be carried on a magnetic disk of a remote computer. The remote computer may load the instructions into its dynamic memory and send the instructions over a telephone line using a modem. A modem local to the computer system 500 may receive the data on the telephone line and use an infrared transmitter to convert the data to an infrared signal. An infrared detector coupled to the bus 502 may receive the data carried in the infrared signal and place the data on the bus 502. The bus 502 carries the data to the memory 506, from which the processing device 504 retrieves and executes the instructions. For example, the instructions received by the memory 506 may be stored in the storage device 510 before or after execution by the processing device 504.

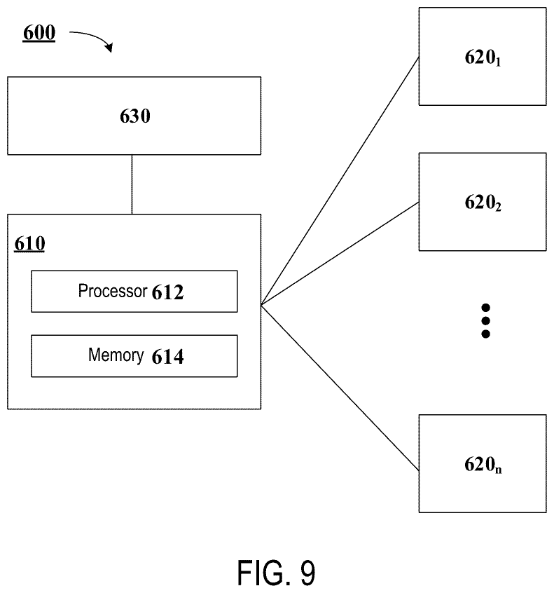

FIG. 9 shows a schematic block diagram of a maintenance system 600 according to some embodiments of the present disclosure. The maintenance system 600 includes an electronic device 610, which includes a processor 612 and a memory 614 coupled to the processor 612 and storing instructions. The electronic device 610 may, for example, take the form of, but is not limited to, the aforementioned electronic device 400 or the computer system 500, and may be implemented as, for example but not limited to, a smartphone, a smart camera, a computer, etc. The memory 614 may store instructions that, when executed by the processor 612, enable the processor 612 to execute the method for processing the recognition result described in any of the aforementioned embodiments of the present disclosure. The maintenance system 600 further includes (one or more) maintenance devices (for example, 620₁, 620₂, . . . , 620ₙ) communicatively coupled with the electronic device 610. The (one or more) maintenance devices are configured to execute the maintenance task in response to receiving commands from the electronic device 610.

Specifically, in some embodiments, the instructions stored in the memory 614, when executed by processor 612, may enable the processor 612 to: obtain the species image from the user and the user's feature information; recognize the image feature of the species image, and extract the content information from the content database based on the recognized image feature; input the content information and the feature information to the large language model to generate the recognition result page from the content information based on the feature information; generate the maintenance plan based on the recognition result page, wherein the maintenance plan includes one or more pairs, each pair in the one or more pairs includes one or more maintenance tasks and the identifier of the maintenance device for execute the one or more maintenance tasks; transmit the command to the corresponding maintenance device (for example, 620₁, 620₂, . . . , 620ₙ) based on the identifier of the maintenance device in each pair in the one or more pairs in the maintenance plan to control the corresponding maintenance device (example, 620₁, 620₂, . . . , 620ₙ) to complete the one or more maintenance tasks in the pair.

In some embodiments, the electronic device 610 includes the user interface (not shown). For example, the recognition result page may be displayed on the user interface, and/or the maintenance plan may be displayed on the user interface.

In some embodiments, the maintenance device (for example, 620₁, 620₂, . . . , 620ₙ) is configured to transmit the execution data to the electronic device 610 in response to execution of the maintenance task. Accordingly, the instructions stored in the memory 614 may include instructions that, when executed by the processor 612, enable the processor 612 to execute the following operations: updating the user's feature information based on the execution data received from the maintenance device. In this way, when the user's species image is acquired again, the recognition result page may be generated in combination with the updated user's feature information, as well as the corresponding maintenance plan.

In some embodiments, the maintenance system 600 may include a camera 630 communicatively coupled with the electronic device 610. The camera 630 may be configured to capture species images and transmit the captured species images to the electronic device 610. Accordingly, the instructions stored in the memory 614 may include instructions that, when executed by the processor 612, enable the processor 612 to perform the following operations: generating the recognition result page based on the species image received from the camera 630.

For example, the species image received from the camera 630 may be input to the aforementioned multimodal model for processing. For instance, as described above, close-up images or videos of one or more feature parts of the target species may be required, in which case the user may not need to input these close-up images or videos, but the camera 630 automatically acquires these close-up images or videos. Alternatively, when the species image from the user cannot be recognized due to various reasons such as insufficient clarity, the user may not need to re-input the species image, but the camera 630 automatically acquires the species image. That is, the image captured by the camera 630 may be used to assist in generating the recognition result.

The camera 630 may be any suitable imaging device for monitoring the target species. The target species may be positioned in the field of view of the camera 630. In some embodiments, instructions stored in the memory 614, when executed by the processor 612, may enable the processor 612 to: acquire the species image from the camera 630 and the feature information of the user; recognize the image feature of the species image, and extract the content information from the content database based on the recognized image feature; input the content information and the feature information to the large language model to generate the recognition result page from the content information based on the feature information; generate the maintenance plan based on the recognition result page, wherein the maintenance plan includes one or more pairs, each pair of the one or more pairs includes one or more maintenance tasks and the identifier of the maintenance device for executing the one or more maintenance tasks; transmit the command to the corresponding maintenance device (for example, 620₁, 620₂, . . . , 620ₙ) based on the identifier of the maintenance device in each pair of the one or more pairs in the maintenance plan to control the corresponding maintenance device (for example, 620₁, 620₂, . . . , 620ₙ) to complete the one or more maintenance tasks in the pair. That is, images captured by the camera 630 may be used to autonomously generate the recognition result and automatically execute the maintenance plan to achieve fully automated monitoring and maintenance of the target species.

Various embodiments of the maintenance system 600 may be similarly referenced to any embodiment in the aforementioned aspects of the present disclosure, and will not be elaborated upon herein.

The above describes one or more exemplary embodiments of the present disclosure. Other embodiments fall within the scope of the appended claims. In some cases, the actions or steps recited in the claims may be executed in a different order than in the embodiments and still achieve the desired results. Additionally, the processes depicted in the drawings do not necessarily require the specific order or sequential order shown to achieve the desired results. In some embodiments, multitasking and parallel processing are also possible or may be advantageous.

The systems, devices, modules, or units illustrated in the above embodiments may specifically be implemented by computer chips or entities, or by products having some functions. A typical implementation device is a server system. Of course, the present disclosure does not exclude that, with the development of future computer technology, the computers for achieving the functions of the above embodiments may be, for example, personal computers, laptop computers, vehicle human-machine interaction devices, cellular phones, camera phones, smart phones, personal digital assistants, media players, game consoles, tablet computers, wearable devices, or any combination thereof.

The terms “include,” “contain,” or any other variants thereof are intended to cover non-exclusive inclusion, such that a process, method, product, or device that includes a series of elements not only includes those elements, but also includes other elements not explicitly listed, or also includes elements inherent to such process, method, product, or device. Without further limitations, it does not exclude the existence of additional identical or equivalent elements in the process, method, product, or device that includes the stated elements. For example, if terms such as “first,” “second,” etc. are used to represent names, they do not indicate any specific order.

For the convenience of description, the above device is described by dividing it into various modules based on function. Of course, when implementing one or more embodiments of the present disclosure, the functions of each module may be implemented in the same one or more software and/or hardware, or modules implementing the same function may be implemented by a combination of multiple sub-modules or sub-units, etc. The device embodiments described above are merely illustrative. For example, the division of the units is merely a logical function division, and there may be other division methods in actual implementation. For example, multiple units or components may be combined or integrated into another system, or some features may be omitted or not executed. Another point is that the mutual coupling or direct coupling or communication connection shown or discussed herein may be realized through some interfaces, and the indirect coupling or communication connection of devices or units may be electrical, mechanical or other forms.

The present disclosure is described with reference to flowcharts and/or block diagrams of methods, devices (systems), and computer program products according to embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing device to generate a machine, such that the instructions executed by the processor of the computer or other programmable data processing device generate a device for implementing the functions specified in one or more processes of the flowchart and/or one or more blocks of the block diagram.

These computer program instructions may also be stored in a computer-readable memory that can guide a computer or other programmable data processing devices to work in a specific method, such that the instructions stored in the computer-readable memory generate a manufactured article including an instruction device, where the instruction device implements the function specified in one flow or multiple flows of the flowchart and/or one block or multiple blocks of the block diagram. These computer program instructions may also be loaded onto a computer or other programmable data processing devices, such that a series of operation steps are executed on the computer or other programmable devices to generate computer-implemented processing, thereby the instructions executed on the computer or other programmable devices provide steps for implementing the function specified in one flow or multiple flows of the flowchart and/or one block or multiple blocks of the block diagram.

Those skilled in the art should understand that one or more embodiments of the present disclosure may take the form of entirely hardware embodiments, entirely software embodiments, or embodiments combining software and hardware aspects. Furthermore, one or more embodiments of the present disclosure may take the form of a computer program product implemented on one or more computer-usable storage media (including but not limited to disk memory, CD-ROM, optical memory, etc.) containing computer-usable program code therein.

One or more embodiments of the present disclosure may be described in the general context of computer-executable instructions executed by a computer, such as program modules. Generally, program modules include routines, programs, objects, components, data structures, etc. that execute specific tasks or implement specific abstract data types. One or more embodiments of the present disclosure may also be practiced in distributed computing environments where tasks are executed by remote processing devices that are connected through a communication network. In distributed computing environments, program modules may be located in both local and remote computer storage media including storage devices.

The same or similar parts between various embodiments of the present disclosure may serve as reference for one other, and each embodiment focuses on illustrating the differences from other embodiments. In particular, for device embodiments, since they are basically similar to method embodiments, the description is relatively simple, and relevant parts may refer to the partial description of the method embodiments. In the description of the present disclosure, reference terms such as “one embodiment”, “some embodiments”, “example”, “specific example”, or “some examples”, “exemplary”, etc., mean that specific features, structures, materials, or characteristics described in combination with the embodiment or example are included in at least one embodiment or example of the present disclosure. In the present disclosure, the schematic expressions of the above terms do not necessarily refer to the same embodiment or example. Moreover, the described specific features, structures, materials, or characteristics may be combined in any one or more embodiments or examples in a suitable method. Furthermore, without mutual contradiction, those skilled in the art may combine and integrate different embodiments or examples described in the present disclosure as well as features of different embodiments or examples.

Additionally, when used in this disclosure, the words “herein”, “above”, “below”, “following”, “preceding” and words of similar meaning should refer to this disclosure as a whole rather than any particular portion of this disclosure. Furthermore, unless otherwise explicitly stated or understood differently in the context in which it is used, conditional language used herein, such as “may”, “might”, “for example”, “such as” and the like, is generally intended to convey that some embodiments include, while other embodiments do not include, some features, elements and/or states. Thus, such conditional language is generally not intended to imply that features, elements and/or states are in any way required by one or more embodiments, or whether these features, elements and/or states are included or performed in any particular embodiment.

The above description is merely an implementation of one or more embodiments of the present disclosure, and is not intended to limit the one or more embodiments of the present disclosure. For those skilled in the art, the one or more embodiments of the present disclosure may have various modifications and variations. Any modifications, equivalent substitutions, improvements, etc. made within the spirit and principle of the present disclosure should be included within the scope of the claims.

What is claimed is:

1. A method for processing a recognition result, comprising:
obtaining a species image from a user and feature information of the user;
recognizing an image feature of the species image, and extracting content information from a content database based on a recognized image feature;
inputting the content information and the feature information to a large language model to generate a recognition result page from the content information based on the feature information;
displaying the recognition result page provided by the large language model on a user interface.

2. The method according to claim 1, wherein the feature information comprises first feature information obtained through historical data of the user,
wherein the first feature information comprises at least one of:
attribute feature information, the attribute feature information comprising maintenance level information, and
operation feature information, the operation feature information comprising maintenance history information.

3. The method according to claim 1, wherein the feature information comprises second feature information obtained through interaction data of the user,
wherein the second feature information comprises demand feature information, and the demand feature information comprises one or more of focused content information, detail preference information, layout preference information, and reading habit information.

4. The method according to claim 1, comprising:
obtaining one or more information from location information, time information, weather information, and climate information of the user;
inputting the species image, the one or more information, and the content information to a multimodal model to adjust the content information based on the species image and the one or more information; and
inputting the adjusted content information and the feature information to the large language model to obtain the recognition result page.

5. The method according to claim 1, comprising:
displaying an interactive question about recognizing the species image on the user interface;
receiving a user input comprising a reply to the interactive question, wherein the user input comprises at least one of image, text, audio, and video;
inputting the species image, the user input, and the content information to a multimodal model to adjust the content information based on the species image and the user input; and
inputting the adjusted content information and the feature information to the large language model to obtain the recognition result page.

6. The method according to claim 1, comprising:
inputting the species image, the content information and a preset content framework to an artificial intelligence generated content (AIGC) model to supplement the content information, wherein the supplemented content information comprises content that is missing from the content information compared to the preset content framework; and
inputting the supplemented content information and the feature information to the large language model to obtain the recognition result page.

7. The method according to claim 1, wherein the feature information comprises focused content information, and the method comprising:
inputting the focused content information, the species image, and the content information to an AIGC model to supplement the content information, wherein the supplemented content information comprises content that is missing from the content information compared to the focused content information; and
inputting the supplemented content information and the feature information to the large language model to obtain the recognition result page.

8. The method according to claim 1, wherein the feature information comprises detail preference information, and the method comprising:
inputting the detail preference information, the species image and the content information to an AIGC model to regenerate the content information, the regenerated content information has a detail level that conforms to the detail preference information; and
inputting the regenerated content information and the feature information to the large language model to obtain the recognition result page.

9. The method according to claim 1, wherein the recognition result page comprises one or more content modules,
wherein the one or more content modules are divided according to topics, the recognition result page further comprises a first-level dividing line located between each of two adjacent content modules in the one or more content modules.

10. The method according to claim 9, wherein the recognition result page further comprises a first-level title located before each of the content modules in the one or more content modules,
wherein the first-level title is determined based on a summary of the content module, or determined based on a key point of the content module.

11. The method according to claim 9, wherein each of content modules in the one or more content modules comprises one or more paragraphs divided according to a contextual relationship, and the recognition result page further comprises a second-level dividing line located between each of two adjacent paragraphs in the one or more paragraphs.

12. The method according to claim 11, wherein the recognition result page further comprises a second-level title located before each paragraph in the one or more paragraphs,
wherein the second-level title is determined based on a summary of the paragraph, or determined based on a key point of the paragraph.

13. The method according to claim 11, wherein a keyword and/or a key sentence in the one or more paragraphs are highlighted,
wherein the one or more paragraphs are arranged according to an ordered list or an unordered list.

14. The method according to claim 1, wherein the large language model is trained with first training data, the first training data comprises a combination of first text indicating content information and second text indicating feature information as samples, the first training data further comprises a recognition result page as a label of the samples.

15. The method according to claim 6, wherein the multimodal model is trained with second training data, the second training data comprises a combination of a species image serving as a sample, first text indicating content information serving as an object to be processed, and data of any one or more modalities indicating reference information serving as a processing reference, the second training data further comprises second text indicating content information serving as a processing result of a label serving as the sample.

16. The method according to claim 8, wherein the AIGC model is trained with third training data, the third training data comprises a combination of a species image serving as a sample, first text indicating content information serving as an object to be processed, and second text indicating reference information serving as a processing reference, the third training data further comprises third text indicating content information serving as a processing result as a label of the sample.

17. The method according to claim 1, comprising:
generating a maintenance plan based on the recognition result page, wherein the maintenance plan comprises one or more pairs, each pair of the one or more pairs comprises one or more maintenance tasks and an identifier of a maintenance device for executing the one or more maintenance tasks;
displaying the maintenance plan on the user interface;
controlling a corresponding maintenance device based on the identifier of the maintenance device in each of the pairs of the one or more pairs in the maintenance plan to complete the one or more maintenance tasks in the pair.

18. A computer program product, the computer program product comprising instructions, wherein the instructions, when executed by a processor, implement the method for processing the recognition result according to claim 1.

19. A maintenance system, comprising:
an electronic device, the electronic device comprising a processor and a memory coupled to the processor and storing instructions, wherein the instructions, when executed by the processor, enable the processor to:
obtain a species image from a user and feature information of the user;
recognize an image feature of the species image, and extract content information from a content database based on a recognized image feature;
input the content information and the feature information to a large language model to generate a recognition result page from the content information based on the feature information;
generate a maintenance plan based on the recognition result page, wherein the maintenance plan comprises one or more pairs, each pair of the one or more pairs comprises one or more maintenance tasks and an identifier of a maintenance device for executing the one or more maintenance tasks;
transmit a command to a corresponding maintenance device based on the identifier of the maintenance device in each of the pairs of the one or more pairs in the maintenance plan to control the corresponding maintenance device to complete the one or more maintenance tasks in the pair; and
a maintenance device communicatively coupled with the electronic device, wherein the maintenance device is configured to execute the maintenance task in response to receiving the command from the electronic device.

20. The maintenance system according to claim 19, wherein the maintenance device is configured to transmit execution data to the electronic device in response to execution of the maintenance task,
wherein the instructions comprise an instruction that, when executed by the processor, enable the processor to execute the following operations:
updating the feature information of the user based on the execution data received from the maintenance device.

21. The maintenance system according to claim 19, comprising:
a camera communicatively coupled to the electronic device, wherein the camera is configured to capture the species image and transmit the captured species image to the electronic device,
wherein the instructions comprise an instruction that, when executed by the processor, enable the processor to perform the following operations:
generating the recognition result page based on the species image received from the camera.
